(19) United States
(12) Patent Application Publication
(10) Pub. No.: US 2016/0176736 A1
(43) Pub. Date: Jun. 23, 2016

(54) TREATMENT FOR DOMESTIC AND INDUSTRIAL WASTE WATER

(71) Applicant: INGENIERIA Y CONSTRUCCION BIOFILTRO LIMITADA, Santiago (CL)

(72) Inventors: Matías Carlos SJOGREN RAAB, Santiago (CL); Alex Manuel VILLAGRA FUENTES, Santiago (CL)

(21) Appl. No.: 14/392,340

(22) PCT Filed: Jun. 24, 2013
(86) PCT No.: PCT/CL2013/000038

§ 371 Date: Dec. 23, 2015

(51) Int. Cl. C02F 9/00; C02F 1/00; C02F 3/02

(52) U.S. Cl. CPC C02F 9/00; C02F 3/02; C02F 1/004; C02F 1/00; C02F 2001/007

(57) ABSTRACT

The present invention refers to a method and system for the treatment of wastewater from domestic and industrial sources that effectively remove the water pollutants, thus reducing the generation of organic residues. The method comprises the stages of: providing wastewater in a wastewater collector (1); conveying at least a portion of said wastewater to a separating unit of coarse solids (2); making said portion of water to undergo filtering in said unit; collecting at least part of the water from the stage (iii), preferably through gravity medium in a first conveying plant (3); conveying at least a portion of the water from the stage (iv) to the separating unit of fine solids (4); making said portion of water to undergo filtering in said unit; collecting at least part of the water from the stage (vi) in a second conveying plant (5); conveying at least a portion of the water from the second conveying plant (5) to the biologic treatment unit (6) through pumping mediums and distribute the water to be treated preferably in homogenous way over said biologic treatment unit (6); making said portion of water to undergo the biologic treatment unit (6); collecting the water treated at the bottom of the biologic treatment unit (6) and optionally convey it to a chemical disinfection unit (8); making said portion of water to undergo treatment in said chemical disinfection unit; and optionally collecting the water treated in the stage (xi) in a container.

### SPECIFICATION

At present, wastewater from domestic and industrial sources should be treated instead of being returned to the environment, so that to avoid generating serious pollution problems to surface waterways, oceans or groundwater, which result in problems to the health of persons and significant environmental damage.

There are about 2.6 billion of people in the world without access to the treatment of wastewater. Said people are mainly concentrated in developing countries and especially in semi-urban and rural areas. Thus, the traditional solutions for the treatment of water cannot be applied to these realities, because they are high-cost systems that demand much energy and sludge-generating synthetic substances, which for their high pollutant load should be carried to an authorized place. To this effect trained personnel is required. This involves a complex expensive operation; thus, conventional solutions are not sustainable to solve the treatment of waters in semi-urban and rural areas.

Therefore, the need remains of providing solutions for the treatment of wastewater in sectors that are not totally urbanized, that involves low energetic, operational cost and does not generate pollutants, but being a simple operation at the same time.

It is in turn more desirable to have a system providing environmental friendly byproducts, as compost (worm humus) and proteins (excess worms).

### BACKGROUND OF THE INVENTION

For a long time, wastewater from domestic and industrial sources was directly discharged into the soil, rivers, lakes, oceans, etc. without considering the environmental damage this caused. When the society realized that this practice generated serious pollution problems to surface and ground waters, in addition to odors, regulations for the discharge of treated waters were started. Today, most countries have their own rules for discharge, since the water resource is increasingly scarce and high levels of pollution are observed, which put future generations at risk.

At present, the infrastructure associated with the treatment of waters has become centralized, i.e. in a certain territory there are thousands of kilometers of sewers or pipelines carrying waters from the consumption point to a great centralized treatment plant. However, due to the increasing need for sustainable and “environmental friendly” alternatives, it is observed that said centralized schemes show the following drawbacks:

1. Since the consumption or discharge point of polluted water is far from the treatment plant, a huge amount of energy is required to pump and then convey the water to be treated to the central plant. Currently, about 15% of energy consumed worldwide is associated with conveying wastewater.

2. In a central sanitation infrastructure, about 90% of the investment is made in the system of sewer or pipelines, which is impractical in many places of the world with lack of resources.

3. There is an associated risk that a whole city may depend on one single central plant and not having alternatives for emergency cases.

At present, the lack of sanitation of wastewater is mainly produced in semi-urban or rural locations, where density is low and, therefore, the water companies do not reach those places, because a centralized solution is not profitable.

Furthermore, conventional technologies for the treatment of waters, such as activated sludge, do not operate well for this semi-urban or rural reality, mainly because:

1. They are high-energy demanding systems.

2. They show high emission of odors; thus, their installation near a human settlement is detrimental and affects the quality of life of those living nearby.

3. They require chemicals and other supplies making it an expensive solution.

4. They generate sludge, which is a material with high pollutant load that cannot be disposed of in the soil due to the environmental damage it generates. Thus, if they are not treated in situ—a very expensive treatment—they should be conveyed to a landfill, but these places have become increasingly scarce. Many times, the sludge is not conveyed, contaminating the environment and producing great harm to the community.

5. They require qualified personnel for the operation.

The most favorable scenario from the point of view of sustainability is that each home or industry may treat the waters contaminated by them. To this, there are a number of systems in the state of the art allowing the treatment of wastewater at a lower scale and with significant economic and environmental advantages.

The state of the art describes methodologies and systems for the biological treatment of waters comprising different treatment stages. The preliminary treatment of water usually involves gravity sedimentation of filtered waters in order to remove suspended solids. About half of suspended solids in wastewater are removed through this pre-treatment.

Then, the second part of the treatment is achieved through a biological process to remove biodegradable material. This treatment uses microorganisms to consume organic dissolved and suspended matter, producing carbon dioxide and other byproducts. The organic matter benefits the microorganisms by providing the necessary nutrients for their viability. When the microorganisms feed from the organic matter, they increase their density and deposit on the bottom separately from the clarified water.

Thus, this system, as known in the state of the art, shows a number of drawbacks and difficulties that reduce its efficiency.

For example, it has been noted that in certain systems, efficacy keeps only for a small period of time. When the wastewater to be treated requires the use of huge amount of biological mass, the problem of “plugging” or “clogging” of the filtering mass arises. This is the result of the waste solids generally depositing on the filtering mass, thus significantly reducing the permeability and contact surface between said medium and the wastewater to be treated and consequently generating at least the following inconvenient:

1) The acceleration of pollutant decomposition by microorganisms is reduced or cancelled.

2) Reduction and even suspension of the water flow to or in the filtering medium.

3) Bad odors resulting from the accumulation of water in the surface and the corresponding “plugging”.

Then, for said decreases to be rectified, generally much larger units should be produced to dampen the decreased efficiency of the system or remedial actions be taken (such as stirring over the filtering medium), thus generating the need for new economic and operating efforts.

Therefore, the need remains for alternative methods and systems that provide a more effective, environmental friendly and economically viable treatment of wastewater.

For these reasons, the system according to the invention has a number of advantages over those described in the state of the art. In particular, it allows the continuity of the system over time, since it is a system in multiple continuous stages. In addition, the system allows minimum generation of organic residues and an improved efficiency of pollutant removal.

### BRIEF DESCRIPTION OF THE STATE OF THE ART

In the state of the art, several systems for the treatment of wastewater have been described.

The Chilean patent CL 40.754 describes a procedure to decontaminate wastewater and liquid industrial residues through a biofilter that uses worms of the Eisenia foetida species. Said procedure is basically a process where the water to be treated goes through 4 serial stages vertically arranged: an initial 25 cm layer of worm humus, a layer of sawdust, a third layer of stones and a final stage of disinfection through UV radiation.

As described in said document, efficient removal of the following would be possible:
DBO5: 95%
Suspended volatile solids: 93%
Volatile solids: 70%
TK nitrogen: 70%
Phosphorus: 70%

In addition, the patent document U.S. Pat. No. 7,540,960 described a method for the treatment of waters by inoculating bacteria using worm humus. In this case, water goes through a first layer of cellulosic origin, which is inoculated through worm humus; a second layer of inert material that can be stones or rocks; and a double bottom providing oxygenation to the bottom by keeping the aerobic condition of the system.

As described in said document, the following efficiency of removal would be possible:
DBO5: 95%
Suspended volatile solids: 93%
Volatile solids: 70%
TK nitrogen: 70%
Phosphorus: 70%

### SUMMARY OF THE INVENTION

The present invention provides a method and a system for the treatment of wastewater from organic domestic and industrial sources.

The method according to the invention comprises at least three different treatment stages. First, the method comprises a treatment stage where mechanical or floating filtering of the water to be treated is performed (primary treatment). Then the water already treated is conveyed to a biologic filtering stage (secondary treatment) where it is contacted by a biologic filtering medium.

This biological treatment unit is composed of units housing different types of microorganisms, worms, fungi, bacteria, among others, which allow turning solid residues into one of the richest composts currently existing, worm humus. With this, the generation of polluting sludge can be dramatically reduced.

The method according to the invention also comprises a third stage of treatment (tertiary treatment), where water from the biological filtering medium is subject to disinfection with chemicals, with the chemical treatment comprising the application of ozone and/or a halogen disinfectant, where the halogen disinfectant can be selected from chlorine, iodine and bromide.

The present invention provides a system preferably arranged for the operation of the treatment method of wastewater described herein. In this respect, the system according to the invention comprises at least a wastewater collector in charge of receiving the wastewater upstream of the treatment system (1), at least a station of mechanic filtering and/or flotation station in charge of removing the solid organic and inorganic residues of a characteristic size, at least one conveyance plant belonging to such filtering station in charge of moving the wastewater in said station, at least a station of biologic filtering in charge of removing the remaining organic residues and at least a disinfection station in charge of disinfecting the effluent from the treatment system through chemicals or another disinfecting medium. Optionally, the system of the invention comprises a unit for the treatment of solids (11), where the organic solid residues removed from the filtering stations are handled.

### BRIEF DESCRIPTION OF THE FIGURES

FIG. 1 shows the layout of the system according to the system.

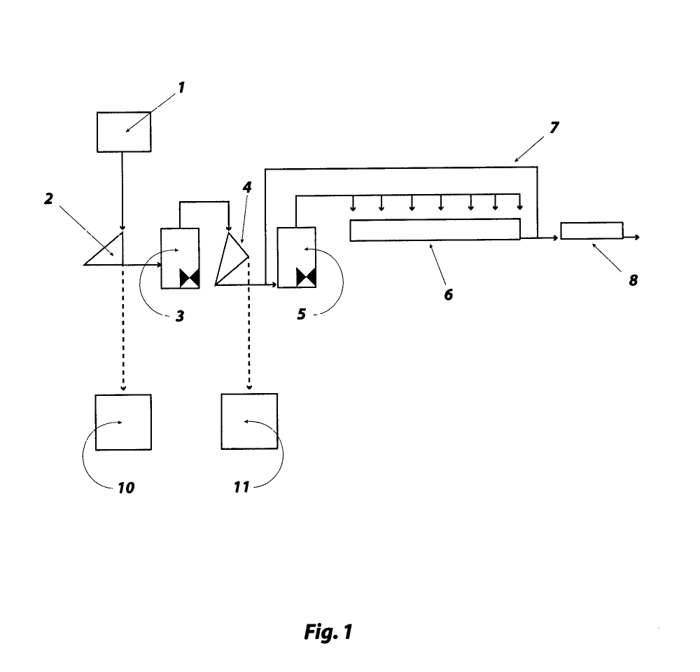

FIG. 2 shows the layout of the biologic treatment unit according to the invention.

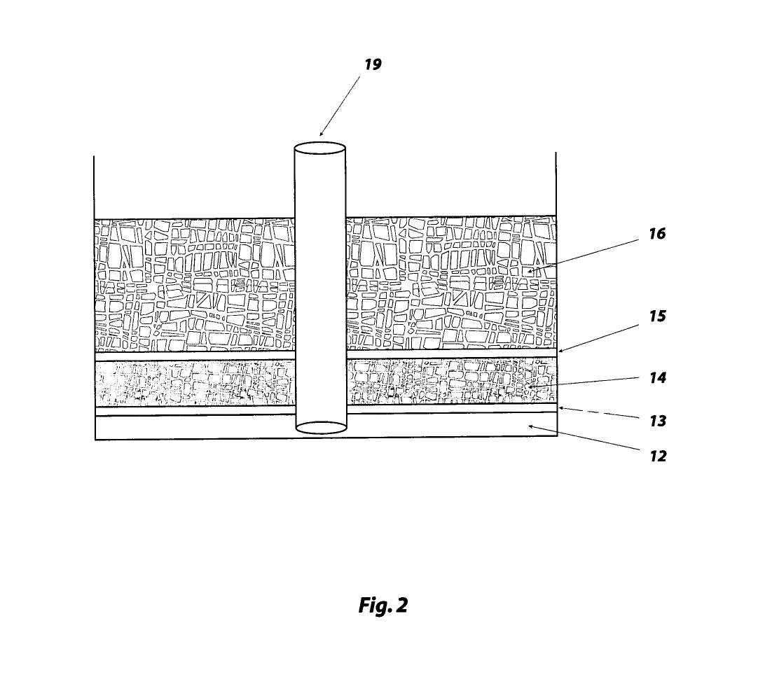

### DETAILED DESCRIPTION OF THE INVENTION

Below, a definition is provided for the following terms and expressions contained in this description:

Wastewater: Wastewater are those liquids used in the daily activities of a city (domestic, commercial, industrial and services). Commonly, wastewater is classified as follows:
Municipal wastewater: Liquid residues conveyed through the sewer system of a city or population and treated in a municipal treatment plant.
Industrial wastewater: Wastewater from discharges of manufacturing industries.
Pollutant sludge: Semisolid residues produced, settled or sedimented during the treatment of waters. They are generated from the septic tanks of houses, commercial centers, offices or industries, or produced by the treatment plants of communal, industrial and commercial waters.

DBO5: The “biochemical” demand of oxygen (DBO) is a parameter measuring the amount of matter liable to be consumed or oxidized through biological medium containing a liquid, dissolved or suspending sample. It is used to measure the pollution degree. Normally, it is measured after five days of reaction (DBO₅) and expressed in milligrams of diatomic oxygen per liter (mgO₂/l).

Volatile suspended solids: They account for the fraction of suspended solids volatilized at 600° C.

Volatile solids: Those volatilized at a temperature of 600° C. If total solids are subject to combustion at a temperature of 600° C. for 20 minutes, the organic matter turns into CO2 and H2O. This loss of weight is interpreted in terms of organic or volatile matter. Solids that are not volatilized are called fixed solids.

TK nitrogen: The total Kjeldahl nitrogen is an indicator use in environmental engineering. It reflects the total quantity of nitrogen in the analyzed water, the sum of organic nitrogen in its different forms (proteins and nucleic acids in different stages of degradation, urea, amines, etc.) and the ion ammonium NH4+.

Mechanic filtering: It is in charge of withholding the solid particles present in the water in its filtering medium.

Biologic filtering: It is in charge of metabolizing the nitrogen substances through a culture of bacteria in its filtering medium.

The present invention provides a method and a system for the treatment of domestic and industrial wastewater from organic sources.

The method according to the invention comprises at least three different stages of treatment. First, the method comprises a treatment stage where a mechanic or flotation filtering is performed of the water to be treated (primary treatment). Then the water already treated is conveyed to a biologic filtering stage (secondary treatment) where it is contacted by a biologic filtering medium.

This biological treatment unit is composed of units housing different types of microorganisms, worms, fungi, bacteria, among others, which allow turning solid residues into one of the richest composts currently existing, worm humus. With this, the generation of polluting sludge can be dramatically reduced.

The method according to the invention also comprises a third stage of treatment (tertiary treatment), where water from the biological filtering medium is subject to disinfection with chemicals, with the chemical treatment comprising the application of ozone and/or a halogen disinfectant, where the halogen disinfectant can be selected from chlorine, iodine and bromide.

In addition, the system of invention comprises at least a wastewater collector, at least an impulsion plant and, optionally, at least a treatment unit of solids.

Below, both the treatment method and the system used for the application of said method are described in further detail.

The invention provides a method of treatment of wastewater from domestic and industrial sources that effectively remove the water pollutants, thus reducing the generation of organic residues and keeping continuous operation, comprising the stages of:

i. providing wastewater in a wastewater collector (1);

ii. conveying at least a portion of said wastewater to a separating unit of coarse solids (2) or coarse filtering station;

iii. making said portion of water to undergo filtering in said separating unit of coarse solids;

iv. collecting at least part of the water from the stage (iii), preferably through gravity medium in a first conveying plant (3); and

v. conveying at least a portion of the water from the stage (iv) to the separating unit of fine solids (4) or fine filtering station;

vi. making said portion of water to undergo filtering in said separating unit of fine solids;

vii. collecting at least part of the water from the stage (vi), preferably through gravity medium in a second conveying plant (5);

viii. conveying at least a portion of the water from the second conveying plant (5) to a biologic treatment unit (6), preferably through pumping medium and distribute the water to be treated preferably in homogenous way over said biologic treatment unit (6);

ix. making said portion of water to undergo treatment in the biologic treatment unit (6);

x. collecting the water treated at the bottom of the biologic treatment unit (6) and convey it to a chemical disinfection unit (8) through gravity medium;

xi. making said portion of water to undergo treatment in said chemical disinfection unit; and

xii. optionally collecting the water treated in the stage (xi) in a container.

In a preferred embodiment, the method according to the invention comprises at least the following stages:

i. providing wastewater in a wastewater collector (1);

ii. conveying at least a portion of said wastewater to the separating unit of coarse solids (2) or coarse filtering station, where said conveyance is performed in ducts through gravity medium and/or pumping mans;

iii. making said portion of water to undergo filtering in said separating unit of coarse solids;

iv. collecting at least part of the water from the stage (iii), preferably through gravity medium in a first conveying plant (3) and optionally collecting the coarse solids of stage (iii) and convey them to a treatment unit of coarse solids (9),

v. conveying at least a portion of the water from the stage (iv) to the separating unit of fine solids (4) or fine filtering station, where said conveyance is optionally performed through pumping mans;

vi. making said portion of water to undergo filtering in said separating unit of fine solids;

vii. collecting at least part of the water from the stage (vi), preferably through gravity medium in a second conveying plant (5) and optionally collecting the fine solids of stage (iv) and convey them to a treatment unit of fine solids (10);

viii. conveying at least a portion of the water from the second conveying plant (5) to a biologic treatment unit (6), preferably through pumping medium and distribute the water to be treated preferably in homogeneous way over said biologic treatment unit (6);

ix. making said portion of water to undergo treatment in the biologic treatment unit (6), preferably at a hydraulic treatment rate between 100 and 1,500 lt/m²/day, and optionally collecting the water treated at the bottom of said unit of biologic treatment after the biologic treatment and making it to undergo recirculation (7), so that to perform at least a new stage of biologic treatment;

x. collecting the water treated at the bottom of the biologic treatment unit (6) and convey it to a chemical disinfection unit (8) through gravity medium;

xi. optionally making said portion of water to undergo treatment in said chemical disinfection unit; and

xii. optionally collecting the water treated in the stage (xi) in a container.

In an embodiment of the invention, after stage vi wastewater is obtained with solids of a diameter less than 1 mm, preferable lower than between 0.5 and 1 mm.

In particular, in the method according to the invention, all solids above 0.5 mm are separated in the initial filtering station and are directly conveyed to the treatment unit of solids that can preferably locate near the biologic treatment unit.

In a preferred embodiment of the invention, recirculation according to stage ix is performed as many times as necessary until the water has the desired concentration of pollutants. In addition, said recirculation is optionally performed to one of the units upstream the biologic treatment unit, preferably to the second conveyance plant.

The biologic treatment unit comprises bacteria of natural heterotrophic highly adaptable bacteria with the capacity of turning pollutants of wastewater into soluble low molecular weight components.

The optional stage of chemical treatment comprises contacting the water to be treated with an effective amount of a chemical, which is preferably selected from a halogen-derived compound, where halogen is selected from the group formed by chlorine, bromide and iodine in amounts ranging between 1-20 ppm, preferably 1-10 ppm and most preferably between 1 and 5 ppm.

According to the invention, the provision of pretreatment stages to the biologic treatment (primary treatment) allows preventing the biologic treatment unit to become saturated with excess solids or fat, thus losing its permeability, as well as water settled and the system become flooded, resulting in a reduction of its flow. At the same time, by having a first stage of pretreatment for solids, the method provides greater efficiency in the removal of the polluting parameters of wastewater.

The invention also has a system to treat wastewater from domestic and industrial sources that removes the water pollutants effectively, reducing the generation of organic solids and keeping the operation continuity, comprising:

a. at least a wastewater collector upstream of the system;

b. at least a mechanic and/or flotation filtering station in charge of removing inorganic and/or organic solids of a given size;

c. at least a biologic filtering station in charge of removing the remaining organic residues; and

d. at least a cleaning station in charge of disinfecting the system's effluent.

In an embodiment, the at least one wastewater collector consists in a tank distributing the wastewater to the mechanic and/or flotation filtering station. In another embodiment, each mechanic and/or flotation filtering station is composed of a filtering medium and a conveyance medium, where the filtering medium is in charge of removing the solids from the effluent and the conveying medium of carrying the effluent to the next stage of the system. Preferably, the at least one filtering station is made up of a plurality of filtering medium and conveyance medium serially arranged.

In addition, the at least one filtering medium consists in a separating unit of solids of a given size and the at least one conveyance medium consists in an effluent impulsion unit in particular, where the location according to the size of particles and the characteristics of the effluent in the filtering station consists in removing the particles of greater size upstream said station until the removal of the particles of lower size downstream said station.

In another embodiment, the separating unit of solids upstream the filtering station consists in a steel grid chamber that includes bars spaced about 3 to 8 centimeters apart. Preferably, the conveyance means located before the biologic filtering station acts as surge tank feeding the biologic treatment unit by absorbing fluctuations of flow.

In another embodiment, in the mechanic and/or flotation filtering station located before the biologic filtering station there is an enhancer of bacterial flora, where said enhancer preferably incorporates to the conveyance means of said filtering station. Preferably the at least one biologic filtering station consists in a biologic treatment unit composed of layers as detailed below. More preferably, the layers of the at least one biologic treatment unit consist in a chamber of air, a first separating unit, an inorganic layer, a second separating unit and an organic layer.

The chamber of air consists in an air gap located at the bottom of the biologic treatment unit, where next to the chamber of air there is a first separating unit that sets a separation between the chamber of air and the layer of inorganic material, keeping the integrity of said chamber of air. In addition, the first separating unit comprises a structure of concrete, cement, plastic and/or cardboard, among others. Additionally, next to the first separating unit there is an inorganic layer made up of at least one inorganic material or a combination thereof.

The layers of inorganic material in any material or mixture of inorganic material are made up by particles between 5 and 15 cm. The layers of inorganic material preferably consist in a layer of plastic and/or stones. Next to the inorganic layer, there is a second separating unit setting a separation between the layer of inorganic material and the layer of organic material, thus preventing the microorganisms to go through from the organic material into the inorganic material.

The second separating unit is selected from a preferably plastic membrane with holes between 0 and 1 mm or any cover or combinations of covers allowing water going through to the lower layer and not allowing worms going through to this lower layer, i.e. it is a mesh of any material with little holes allowing water to pass through. Next to the second separating unit there is an organic layer comprising derivatives from the cellulose, worms, bacteria and other microorganisms allowing to filtering the pollution in solid and soluble state from the wastewater. In addition over the organic layer the inoculation of microorganisms takes place, as well as the spraying of the effluent from the filtering station located before the biologic treatment unit. There is at least one ventilation means communicating the chamber of air with the outside of the biologic treatment unit, so that to provide ventilation to the different layers of said unit through holes located along said means. The ventilation means correspond to any element allowing fluid communication between the chamber of air, the outside of the biologic treatment unit and the layers making them up, as a drilled duct going through said layers vertically. The at least one cleaning station is made up by one cleaning unit corresponding to a tank designed to add a disinfection chemical that remains in contact with the system's effluent for the proper period of time to disinfect said effluent properly.

In one embodiment the system can comprise a roof blocking sunlight and incident radiation over the biologic treatment unit. Optionally it is possible to install a plurality of biologic treatment units serially. The recirculation of at least part of the effluent from the biologic treatment unit can be used towards one of the filtering stations located upstream said unit.

In a preferred embodiment, the system according to the invention comprises at least the following constituent elements:
Wastewater collector (1): the unit in charge of receiving wastewater and arranging its distribution in the treatment system. It is located upstream the system and it should have the capacity of collecting the water to be treated, so that to provide a flow of effluent under treatment according to the capacities of the system. In a preferred embodiment this unit is made up by a tank for the distribution of wastewater.
Coarse solids separator (2): a unit composed of one of the filtering means of the mechanic and/or flotation filtering station, where the greater size solids are removed from the effluent under treatment. This unit consists in a steel grid chamber including bars spaced about 3 to 8 centimeters apart and allowing the filtration of solids of greater diameter than the aforementioned dimensions.
First impulsion plant (3): a unit corresponding to one of the conveyance plants, which preferably use pumps as conveyance means of the effluent coming from the previous unit. In particular, this first conveyance unit is in charge of receiving the effluent from the first filtering station and sending it to the second filtering station according to the requirements of said station.
Fine solids separator (4): a unit composed of one of the filtering means of the mechanic and/or flotation filtering station, where the greater size solids are removed from the effluent under treatment. This unit mainly consists in a piece of equipment having a steel grid with little holes, through which the water runs by gravity with the solids being removed remaining on the mesh. In this case, the steel mesh or grid has holes of about 0.5 to 1 mm allowing the filtration of solids of greater diameter than the aforementioned dimensions.
Second impulsion plant (5): a unit corresponding to one of the conveyance plants, which preferably use pumps as conveyance means of the effluent coming from the previous unit. In particular, this second conveyance unit is in charge of receiving the effluent from the second filtering station and sending it to the biologic filtering station according to the requirements of said station. In this context, one of its purposes is accruing water, thus becoming a surge tank before a possible increase of discharges in short periods of time, since the impulsion from this body to the biologic treatment unit (6) is performed by irrigating a constant flow and with constant stops.
Biologic treatment unit (6): it consists in a biologic filter in charge of removing the organic residues remaining from previous stages trough microorganisms, worms, fungi and bacteria.
Disinfection unit (8): it consists in a disinfection unit of the effluent coming from the biologic filtering, where the final properties of the effluent are provided that will be produced from the treatment system of wastewater. In this context, this unit mainly consists in a tank designed for the water to follow a circulation in which the necessary time will be reached for the water to get in contact with a disinfectant agent, so that the final disinfection of the effluent becomes effective.

In an even more preferably embodiment, the biologic treatment unit (6) according to the invention comprises the following stages from its bottom area upwards:
Chamber of air (12): a lower layer allowing to contributing oxygen to the bottom of the biologic filter. In this context, the biologic treatment unit (6) operating in aerobic conditions and keeping the right oxygenation in all layers that make up said unit remains to be very important. In this context there are ventilation means connecting the chamber of air at the bottom of the biologic treatment unit to the bottom of the unit and the outside, providing air to the layers that make the unit. The flow generated between the chamber of air and the outside will mainly depend on the differences of temperature between these two pints, i.e. the temperature gradient.
First separating unit (13): a layer that sets a separation between the chamber of air (12) and the layer of inorganic material (14), where said separating unit can comprise concrete-, cement-, plastic, cardboard-based elements, among others, so that to keep the integrity of the chamber of air, i.e. that there is no air leak to the outside of the chamber and/or input of pollutants to it.
Layer of inorganic material (14): a layer composed of an inorganic material or combination thereof, where the inorganic material or materials are selected from plastic, stones, etc. (indicate possible additional alternatives). If plastics are used, different forms are considered of a size of about 5-15 cm diameter and if stones are used, gravel can be used also of diameters between 5-15 cm. i.e. the inorganic material of this layer must be comprised by particles of a size between 5 and 15 cm. In addition, in the layer of inorganic material (n) bacteria are housed that mainly reduce the soluble pollution of water.
Second separating unit (15): a layer that sets a separation between the layer of inorganic material (14) and the layer of organic material (16), thus preventing that microorganisms may go through from the cellulosic organic material (16) into the inorganic material (14), where said separating unit is selected from a preferably plastic membrane with holes between 0 and 1 mm or any cover or combination of covers allowing water to pass to the lower layer and not allowing worms to pass to this lower layer, i.e. it is a mesh of any material with little holes allowing water to pass.
Layer of organic material (16): upper layer comprising cellulose derivatives, worms, bacteria and other microorganisms allowing to filtering pollution in solid and soluble state of wastewater.
Ventilation means (19): means arranged from the chamber of air (12) to the surface of the organic material (16), which allow communicating the chamber of air (12) with the outside and allow a flow of air, so that to provide oxygen to the bottom of the biologic treatment unit (6), thus keeping the aerobic conditions required by the system. In this context, the biologic treatment unit comprises at least a ventilation means, which can be a tube, where said ventilation means has holes along it and, therefore, it will give oxygenation to the whole column making up the stratum of the biologic treatment unit. In addition, adding forced ventilation at the bottom chamber is possible through fans or other mechanisms that force oxygenation, so that the latter may rise through the column and supply a greater amount of oxygen in the lower layers of the biologic treatment unit, which are those with a poorer concentration of oxygen.

In an embodiment of the invention, the mechanic and/or flotation filtering station can comprise a plurality of filtering and conveyance means, so that to improve the removal of solid particles containing the effluent under treatment. In this context, the combination of filtering and conveyance means should be such that the conveyance means meet the requirements to convey the effluent from a filtering mean upstream thereof towards filtering means downstream the same. In this respect, the filtering and conveyance means located before the biologic treatment unit are especially important, since they should meet the supply requirements of the biologic treatment unit.

With respect to the filtering means in question, this can be from a simple steel grid to retain any solid greater than 0.5 mm to a DAF (Dissolved Air Flotation) equipment, which—through bubbles—gets to remove matters that are difficult to separate mechanically with a grid. These matters can be oil and grease from industrial processes carried out in industries processing dairy products and/or sausages, among others. Thus, the water can be left with the proper level of solids to enter the conveyance means in question, which unit supplies the biologic treatment unit. With respect to the conveyance means in question, this unit should have the capacity of supplying the necessary flow characteristics to the feeding effluent of the biologic treatment unit. In this context, the main characteristic imparted by this means to the supply effluent corresponds to continuous supply acting as surge tank before possible increases of discharges in short periods of time, since the impulsion from this body to the biologic treatment unit (6) is carried out through constant flow irrigation with constant stops.

Then, the supply to the biologic treatment unit is carried out without any kind of flooding and/or operation that may require excess maintenance, so that to choose the greatest efficiency of the system. In this context, it is important to note that the separating unit of fine solids or fine filtering medium also allows withholding oils and greases that can make the surface of the biologic bed watertight in the biologic treatment unit according to that mentioned above. Then, although the separator of fine solids allows separating most of excess grease, the grease or oil going to the biologic treatment unit permeate the surface of the upper layer of said unit; here, they are consumed by the worms and bacteria housed in the biologic treatment unit.

With respect to the biologic treatment unit according to the invention, an initial inoculation of microorganisms is performed when putting the system into operation in order to provide the biologic load required. Though a natural process, the microorganisms present in said inoculation will incorporate to the organic origin layer (16), thus forming the bacterial flora that contributes to decontamination and, by the operation of the system, the bacteria will populate the lower layers, mainly the layer or inorganic material. Preferably, the initial inoculation comprises providing an amount of 500-10,000 worms/m2 and about 0.5.5 kg of humus/m2.

In addition, over the biologic treatment unit (6) it is possible to implement a roof, since the microorganisms coexisting inside this unit (6) prefer shadow, humid environments; therefore, exposing the surface of the biologic treatment unit (6) directly to sun radiation is not advisable.

Additionally, there is also the possibility of installing another serial biologic unit or the biologic units that can be necessary. Thus, 100% of water goes through the first unit; after that, 100% of the effluent from the first unit goes through a second unit and so on and so forth, until reaching an effluent of the quality according to the requirements desired by the system. In this context, it is also possible adding a recirculation station to the outlet of the biologic treatment unit, so that at least one part of the effluent of said unit returns to previous stations to the biologic treatment unit, in particular any of the filtering stations, more in particular the filtering station located before the biologic unit, whether to the filtering means or to the conveyance means. Then, the object of said recirculation is to make at least part of the effluent to be filtered again, whether only by the biologic treatment unit or by a combination of at least one filtering station with said unit; this way, an effluent meeting the requirements set for the system is obtained. The main difference between providing recirculation and serial biologic treatment units is that by using serial biologic treatment units, they can better adapt to treat effluents of different characteristics according to the stage of said effluent, while by using recirculation only the effluent under recirculation enters the same unit used with the initial effluent. This can result in damaging the characteristics of the effluent under recirculation, but not affect the characteristics of the final effluent.

In addition, in at least one of the mechanic and/or flotation filtering an enhancer of bacterial flora incorporates, particularly to the conveyance means located before the biologic treatment unit. This way, we try to enhance the bacterial flora in the biologic unit to increase its concentration, thus having a greater percentage of organic solids removed. Said enhancer can be a mixture of bacteria, yeasts or any other type of components allowing to increasing the bacterial flora in a medium.

In an embodiment, the enhancer of the bacterial flora of the invention consists in mixing nutrients in inert state, which incorporates in amounts of:
Between 100 and 2000 g in the start-up stage by each m3/day of installed capacity of water treatment.
Between 5 and 1000 g in the stage of rated operation by each m3 of water treated.

Preferably, the enhancer of the bacterial flora comprises, in weight, about 20-50% of carbohydrates, 20-50% of amino acids, 1-20% of lipids and 1-30% of traces (vitamins and minerals among others).

Through the method and systems described herein, providing a treatment for wastewater is possible, where the water treated can be used in different applications, such as, irrigation, washing and other industrial processes.

Advantageously, the method and system of the invention have the following characteristics:
Low generation of odors
Negligible generation of organic residues
Low energy consumption, between 0.05-1 Kwh/m3 of water treated.
Low consumption of disinfecting chemicals.

The example below describes the invention in further detail and it intends to be a way to illustrate, but to limit, the invention.

### EMBODIMENT EXAMPLE

The method and system of the present invention were arranged in a treatment plant that treats the wastewater of a casino and hotel located in the region of Valparaíso, Chile.

A number of treatments were performed using the method and system described herein.

The system has all the elements described in the section “Detailed description of the invention”.

In particular, it comprises:
A separating unit of coarse solids (2)
Impulsion plant (3)
A separating unit of fine solids (4) consisting in a parabolic 0.5 mm separation filter, manufactured of a steel mesh (4).
Second impulsion plant (5).
A biologic treatment unit (6).
A disinfection unit (8).
A coarse solids treatment unit (9).
A fine solids treatment unit (10).

Below, the results of 2 analyses of waters of the effluent and affluent of the treatment plant are shown.

Analysis 1—Treatment Plant 1—October 2012

| | Affluent | Effluent | % Remission |
|---|---|---|---|
| DBO5 (mg/l) | 1956 | 13 | 99% |
| Total suspended | 1010 | 47 | 95% |
| solids (mg/l) | | | |
| Nitrogen (mg/l) | 103 | 28 | 73% |
| Phosphorus (mg/l) | 43 | 7 | 84% |
| Oils and greases | 239 | 4 | 98% |
| (mg/l) | | | |
| Fecal coliforms | | <2 | 100% |
| (NMP/100 ml) | | | |

pH [affluent]: between 6.0-8.5

Temperature: between 23.5 and 26° C.

Average flow: 3.1 liters/sec (maximum: 4.5, minimum 1.4)

Biologic unit surface: 400 m2

Estimated withdrawal of solids: 50 kilos/day

Disinfectant: 3 ppm of chlorine

Recirculation by biologic treatment unit: No

Analysis 2—Treatment Plant 2—June 2012

| | Affluent | Effluent | % Remission |
|---|---|---|---|
| DBO5 (mg/l) | 567 | 8 | 99% |
| Total suspended | 1385 | 1 | 100% |
| solids (mg/l) | | | |
| Nitrogen (mg/l) | 52 | 9 | 83% |
| Phosphorus (mg/l) | 8 | 3 | 63% |
| Oils and greases | 78 | 4 | 95% |
| (mg/l) | | | |
| Fecal coliforms | | <2 | 100% |
| (NMP/100 ml) | | | |

pH [affluent]: between 7.5-7.6

Temperature: between 22 and 23° C.

Average flow: 1.3 liters/sec (maximum: 2.3, minimum 0.2)

Biologic unit surface: 400 m2

Estimated withdrawal of solids: 40 kilos/day

Disinfectant: 3 ppm of chlorine

Recirculation by biologic treatment unit: No

Results of pollutants removal
DBO5: 70%-100%
SST (Total Suspended Solids): 70%-100%
TK nitrogen: 50%-90%
Phosphorus: 50%-80%
Oils and greases: 70%-100%
Fecal coliforms: 90%-100%

According to the explanation above, it results that conventional technologies do not provide a sustainable solution to the problem. The biofilter does solve the problem from the sustainability perspective, since it has direct impact on the 3 pillars making up sustainability, i.e. a low-cost, competitive solution (economic impact), as well as odorless, without sludge generation and low energy and chemical consumption (environmental impact), eventually being a solution that can be operated by the community itself unlike conventional technologies that require qualified personnel (social impact).

1. A method of treatment of wastewater from domestic and industrial sources that effectively remove the water pollutants, thus reducing the generation of organic residues and keeping continuous operation, WHEREIN it comprises the stages of:
i. providing wastewater in a wastewater collector (1);
ii. conveying at least a portion of said wastewater to a separating unit of coarse solids (2) or coarse filtering station;
iii. making said portion of water to undergo filtering in said separating unit of coarse solids;
iv. collecting at least part of the water from the stage preferably through gravity medium in a first conveying plant (3); and
v. conveying at least a portion of the water from the stage (iv) to the separating unit of fine solids (4) or fine filtering station;
vi. making said portion of water to undergo filtering in said separating unit of fine solids;
vii. collecting at least part of the water from the stage (vi), preferably through gravity medium in a second conveying plant (5);
viii. conveying at least a portion of the water from the second conveying plant (5) to a biologic treatment unit (6), preferably through pumping medium and distribute the water to be treated preferably in homogenous way over said biologic treatment unit (6);
ix. making said portion of water to undergo treatment in the biologic treatment unit (6);
x. collecting the water treated at the bottom of the biologic treatment unit (6) and convey it to a chemical disinfection unit (8) through gravity medium;
xi. making said portion of water to undergo treatment in said chemical disinfection unit; and
xii. optionally collecting the water treated in the stage (xi) in a container.

2. The method according to claim 1, WHEREIN conveyance in the coarse filtering treatment stage is performed through ducts by gravity means and/or pumping means.

3. The method according to claim 1 or 2, WHEREIN stage iv optionally comprises collecting coarse solids from the stage (iii) and convey them to a coarse solids treatment unit (9).

4. The method according to any of previous claims, WHEREIN conveyance in the fine filtering treatment stage is performed through ducts by pumping means.

5. The method according to any of previous claims, WHEREIN stage vii optionally comprises collecting fine solids (4) from the stage vi and convey them to a solids treatment unit (10).

6. The method according to any of previous claims, WHEREIN in stage viii the distribution of water to be treated over the biologic treatment unit is performed through an irrigation network.

7. The method according to any of previous claims, WHEREIN in stage ix a hydraulic treatment rate is provided ranging between 100 and 1,500 L/m2/day.

8. The method according to any of previous claims, WHEREIN stage ix also comprises collecting the water treated at the bottom of said biologic treatment unit after the biologic treatment and making said water to undergo recirculation, so that to perform at least a new stage of biologic treatment.

9. The method according to any of previous claims, WHEREIN in stage x the conveyance of water treated is performed by gravity means.

10. The method according to any of previous claims, WHEREIN the optional stage of chemical disinfection comprises contacting the water to be treated with an effective amount of a chemical, which is preferably selected from a halogen-derived compound, where halogen is selected from the group formed by chlorine, bromide and iodine in amounts ranging between 1-20 ppm, preferably 1-10 ppm and most preferably between 1 and 5 ppm.

11. A system to treat wastewater from domestic an industrial sources that removes the water pollutants effectively, reducing the generation of organic solids and keeping the operation continuity, comprising:
a. at least a wastewater collector upstream of the system;
b. at least a mechanic and/or flotation filtering station in charge of removing inorganic and/or organic solids of a given size;
c. at least a biologic filtering station in charge of removing the remaining organic residues; and
d. at least a cleaning station in charge of disinfecting the system's effluent.

12. The system according to claim 1, WHEREIN the at least one wastewater collector consists in a tank to distribute wastewater to the mechanic and/or flotation filtering station.

13. The system according to any of the previous claims, WHEREIN each mechanic and/or flotation filtering station is composed of a filtering medium and a conveyance medium, where the filtering medium is in charge of removing the solids from the effluent and the conveying medium of carrying the effluent to the next stage of the system.

14. The system according to claim 3, WHEREIN the at least one filtering station is made up of a plurality of filtering mediums and conveyance mediums serially arranged.

15. The system according to claims 3 and 4, WHEREIN the at least one filtering medium consists in a separating unit of solids and the at least one conveyance medium consists in an effluent impulsion unit in particular, where the location according to the size of particles and the characteristics of the effluent in the filtering stage consists in removing the particles of greater size upstream said stage until the removal of the particles of lower size downstream said stage.

16. The system according to claim 5, WHEREIN the separating unit of solids upstream the filtering station consists in a steel grid chamber that includes bars spaced about 3 to 8 centimeters apart.

17. The system according to any of the previous claims, WHEREIN the conveyance means located before the biologic filtering station acts as surge tank feeding the biologic treatment unit by absorbing fluctuations of flow.

18. The system according to any of the previous claims, WHEREIN in the mechanic and/or flotation filtering station located before the biologic filtering station there is an enhancer of bacterial flora incorporated, where said enhancer preferably incorporates to the conveyance means of said filtering station.

19. The system according to any of the previous claims, WHEREIN the at least one biologic filtering station consists in a biologic treatment unit composed of layers.

20. The system according to claim 9, WHEREIN the layers of the at least one biologic treatment unit consist in a chamber of air, a first separating unit, an inorganic layer, a second separating unit and an organic layer.

21. The system according to claim 10, WHEREIN the chamber of air consists in an air gap located at the bottom of the biologic treatment unit.

22. The system according to any of claims 10 and 11, WHEREIN next to the chamber of air there is a first separating unit that sets a separation between the chamber of air and the layer of inorganic material, keeping the integrity of said chamber of air.

23. The system according to claim 12, WHEREIN the first separating unit comprises a structure of concrete, cement, plastic and/or cardboard, among others.

24. The system according to any of claims 10 to 13, WHEREIN next to the first separating unit there is an inorganic layer made up of at least one inorganic material or a combination thereof.

25. The system according to claim 12, WHEREIN the layers of inorganic material in any material or mixture of inorganic material are made up by particles between 5 and 15 cm.

26. The system according to claims 14 and 15, WHEREIN the layers of inorganic material preferably consist in a layer of plastic and/or stones.

27. The system according to any of claims 10 to 16, WHEREIN next to the inorganic layer, there is a second separating unit setting a separation between the layer of inorganic material and the layer of organic material, thus preventing the microorganisms to go through from the organic material into the inorganic material.

28. The system according to claim 17, WHEREIN the second separating unit is selected from a preferably plastic membrane with holes between 0 and 1 mm or any cover or combinations of covers allowing water going through to the lower layer and not allowing worms going through to this lower layer, i.e. it is a mesh of any material with little holes allowing water to pass through.

29. The system according to any of claims 10 to 18, WHEREIN next to the second separating unit there is an organic layer comprising derivatives from the cellulose, worms, bacteria and other microorganisms allowing to filtering the pollution in solid and soluble state from the wastewater.

30. The system according to any of claims 10 to 18, WHEREIN next to the second separating unit there is an organic layer comprising derivatives from the cellulose, worms, bacteria and other microorganisms allowing to filtering the pollution in solid and soluble state from the wastewater.

31. The system according to claim 19, WHEREIN over the organic layer the inoculation of microorganisms takes place, as well as the spraying of the effluent from the filtering station located before the biologic treatment unit.

32. The system according to claim 31, WHEREIN a single initial inoculation of microorganisms is performed.

33. The system according to any of claims 10 to 20, WHEREIN there is at least one ventilation means communicating the chamber of air with the outside of the biologic treatment unit, so that to provide ventilation to the different layers of said unit through holes located along said means.

34. The system according to claim 21, WHEREIN the ventilation means correspond to any element allowing fluid communication between the chamber of air, the outside of the biologic treatment unit and the layers making them up, as drilled duct going through said layers vertically.

35. The system according to any of claims 11 to 34, WHEREIN the at least one cleaning station is made up by one cleaning unit corresponding to a tank designed to add a disinfection chemical that remains in contact with the system's effluent for the proper period of time to disinfect said effluent properly.

36. The system according to any of claims 11 to 35, WHEREIN the system comprises a roof blocking sunlight and incident radiation over the biologic treatment unit.

37. The system according to any of claims 11 to 36, WHEREIN it consists in a plurality of biologic treatment units serially arranged.

38. The system according to any of claims 11 to 37, WHEREIN the recirculation of at least part of the effluent from the biologic treatment unit is used towards one of the filtering stations located upstream said unit.
